(19) United States
(12) Patent Application Publication
(10) Pub. No.: US 2017/0262485 A1
(43) Pub. Date: Sep. 14, 2017

(54) NON-TRANSITORY COMPUTER-READABLE RECORDING MEDIUM, DATA MANAGEMENT DEVICE, AND DATA MANAGEMENT METHOD

(71) Applicant: FUJITSU LIMITED, Kawasaki-shi (JP)

(72) Inventor: Toshiaki SAEKI, Kawasaki (JP)

(73) Assignee: FUJITSU LIMITED, Kawasaki-shi (JP)

(21) Appl. No.: 15/425,294

(22) Filed: Feb. 6, 2017

(30) Foreign Application Priority Data
Mar. 9, 2016 (JP) 2016-046106

(51) Int. Cl. G06F 17/30; G06F 11/14

(52) U.S. Cl. CPC G06F 17/30345; G06F 17/30598; G06F 11/1451; G06F 2201/80; G06F 2201/84; G06F 17/3048; G06F 17/30312

(57) ABSTRACT

A data management method conducted by a computer, the data management method that includes generating grouping information that groups data based on a history of a request for an access to the data, accumulating, in a buffer, according to a changing request or changing processing, a changed piece of data from among pieces of data included in a group that exists in a memory, the changed piece of data indicating a piece of data changed by the changing request or the changing processing, the changing request requesting a change in data that includes an addition, an update, and a deletion, the changing processing being processing of changing a group to which the data belongs, and determining, for each group included in the grouping information, whether the changed data accumulated in the buffer is to be written to a storage device, based on a set condition for writing.

### CROSS-REFERENCE TO RELATED APPLICATION

This application is based upon and claims the benefit of priority of the prior Japanese Patent Application No. 2016-046106, filed on Mar. 9, 2016, the entire contents of which are incorporated herein by reference.

### FIELD

The embodiments discussed herein are related to a non-transitory computer-readable recording medium, a data management device, and a data management method.

### BACKGROUND

A storage has a low throughput in an irregular access to small-size data, and a cost for random access is higher than a cost for sequential access. A cache technology is a technology that improves the throughput.

The cache technology is a technology that shortens a processing time by use of a memory in order for a controller with a high processing speed to read data faster from a low-speed storage. When a controller reads data from a low-speed storage, it is possible to read the read data from a memory from the next time if the read data is held temporarily in the memory, the memory being readable and writable faster than a hard disk.

A least-recently-used (LRU) cache technology is an example of the cache technology. The LRU cache technology is an algorithm with a basic idea that, when a low-capacity and high-speed storage (such as a cache memory) fills up, a piece of data that has been unused for the longest period of time from among the pieces of data stored therein is saved in a high-capacity and low-speed storage (such as a main storage). The LRU cache technology is an algorithm that is able to be effective without knowledge of a logic of an application program, and exerts an effect only when the same data is repeatedly accessed in a short period of time (when the data is in a cache). The cache lifetime of data is determined according to an amount of cache memory, but the technology has no effect on a repeated data access in a cycle that exceeds the cache lifetime of the data.

When mass data is processed beyond a memory capacity, a data processing performance will be greatly decreased due to a disk being accessed often.

Thus, as a cache technology, a technology (hereinafter referred to as a data relocation technology) was proposed. The technology brings together pieces of data having a relationship into an identical segment on the basis of an access history, so as to perform data relocation.
Patent Document 1: International Publication Pamphlet No. WO 2013/114538
Patent Document 2: Japanese Laid-open Patent Publication No. 10-161938
Patent Document 3: Japanese Laid-open Patent Publication No. 2001-34535
Patent Document 4: Japanese Laid-open Patent Publication No. 8-137753
Patent Document 5: Japanese Laid-open Patent Publication No. 2009-104687

### SUMMARY

According to an aspect of the embodiments, a non-transitory computer-readable recoding medium having stored therein a data management program that causes a computer to execute a process that includes generating grouping information that groups data based on a history of a request for an access to the data, accumulating, in a buffer, according to a changing request or changing processing, a changed piece of data from among pieces of data included in a group that exists in a memory, the changed piece of data indicating a piece of data changed by the changing request or the changing processing, the changing request requesting a change in data that includes an addition, an update, and a deletion, the changing processing being processing of changing a group to which the data belongs, and determining, for each group included in the grouping information, whether the changed data accumulated in the buffer is to be written to a storage device, based on a set condition for writing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a data management device according to embodiments;

FIG. 2 illustrates an example of a hardware configuration of the data management device according to the embodiments;

FIG. 3 illustrates an example of a functional configuration of the data management device according to the embodiments;

FIG. 4 illustrates an example of a data allocation table according to the embodiments;

FIG. 5 illustrates an example of a buffer group according to the embodiments;

FIG. 6 illustrates an example of an update amount table according to the embodiments;

FIG. 7A illustrates a flow when a group is updated by performing a data updating (including a deletion) or a data relocation according to the embodiments (Part 1);

FIG. 7B illustrates the flow when a group is updated by performing a data updating (including a deletion) or a data relocation according to the embodiments (Part 2);

FIG. 8 illustrates a flow when a cache of a target group is discarded according to the embodiments;

FIG. 9 illustrates a flow of other buffer-group-entry processing (S22, S54);

FIG. 10 illustrates a flow of processing of reading a group according to the embodiments;

FIG. 11 illustrates a processing flow when a remaining capacity of the buffer group has become low according to the embodiments; and

FIGS. 12A to 12E are diagrams that explain an example of the embodiments.

### DESCRIPTION OF EMBODIMENTS

A data relocation technology is a technology that relocates data so as to reduce a read cost in a subsequent access, but data relocation involves a certain cost. A relationship between an advantage of data relocation and a cost due to data relocation depends on a state of data access (the characteristics of an application program that performs data access).

Writing performed by an application and writing due to relocation can be performed at the same time, so it is possible to conceal a cost for the writing due to relocation. However, for example, if an application program (hereinafter referred to as an “application”) does not perform writing or only performs a small amount of writing, a cost will be greater than that in the case of other technologies such as the LRU because it is not possible to sufficiently conceal a cost for writing due to relocation. On the other hand, it is difficult to obtain an advantage of data relocation if relocation is not performed, so it is also not appropriate to suppress relocation.

In the data relocation technology, pieces of data related to one another are grouped and stored in a storage as continuous areas.

When data is accessed, pieces of data are read from the storage and cached on a memory for each group to which they belong. It is expected that pieces of data in a cached group can be accessed by just performing a single random access. A group has a larger size than a single piece of data, so an access cost is increased, but it is a slight increase compared to a cost for a random access.

When pieces of data that have a high relationship with each other are detected in the memory, content of grouping is changed as needed while the pieces of data are cached in the memory (a group to which data belongs is changed). This is called data relocation.

When there is a lack of vacant capacity in the memory, a group that is less frequently accessed is discarded from the cache earlier. When a change in a group has been performed (when data that belongs to the group has been updated, or when grouping has been updated due to relocation), writing back to a disk is performed for each group using the LRU.

This makes it possible to access data included in a group cached in the memory without any additional cost for a storage access until the group is written back to the storage, which results in being able to reduce an access cost. Namely, no matter how many pieces of data are accessed, it is possible to cover these accesses with “an access cost for a group an access cost for a single piece of data”.

The technology exerts an effect when pieces of data in the same group are accessed in a short term in which the group is in a cache. Namely, an access to a different piece of data is acceptable if it is not a re-access to the same piece of data as in the case of the LRU, but if it is a re-access to the same group. Further, an effect such as a read-ahead cache technology is obtained.

As a value that indicates a relationship between pieces of data, how many pieces of data were accessed while their group was in a cache is referred to as a “number of data reuses”. Further, an average number of data reuses when the data relocation technology is used in a certain application program (hereinafter referred to as an “application”) is referred to as an “average number of data reuses”.

Furthermore, a cache effect is generated both when the data relocation technology is used and when the LRU cache technology is used, so a repeated access to the same piece of data is counted as one access.

However, a scheme of the data relocation technology involves high costs, and it is difficult to meet conditions to provide a performance higher than the LRU cache technology. The conditions are discussed below using examples.

For example, it is assumed that there is a hard disk drive (HDD) in which sequential read and write are both 100 MB/s and random read and write are both 10 ms. It is assumed that each piece of data has a size of 1 KB. In this case, the following are costs in the case of the LRU.

### (Cost in Case of LRU)

A cost for reading a piece of data is obtained by 10 [ms]+1 [KB]/100 [MB/s]=10 [ms]+0.01 [ms]=10.01 [ms]. The cost is generated when an initial reading is performed, and is zero when the piece of data is in a cache.
A cost for writing a piece of data is obtained by 10 [ms]+1 [KB]/100 [MB/s]=10 [ms]+0.01 [ms]=10.01 [ms] (which is equal to the cost for reading). The cost is generated only when a last writing back is performed, and is zero until then.

### (Cost in Case of Data Relocation Technology)

On the other hand, the following are costs in the case of the data relocation technology. Here, it is assumed that a group size=1 MB.
A cost for reading a group all together from a storage is obtained by 10 [ms]+1 [MB]/100 [MB/s]=20 [ms].
A cost for writing a group all together to the storage is also obtained by 10 [ms]+1 [MB]/100 [MB/s]=20 [ms].
Even if only one piece of data is read, there is a need to read a group all together to which the piece of data belongs.

When a group to which a piece of data belongs is not in a cache, a cost when there is a need for writing back is obtained by 20 [ms]+20 [ms]=40 ms. This is about four times the cost for reading apiece of data 10.01 [ms], so it is not possible to provide a performance higher than that of the LRU cache if the number of reuses is not less than four.

Further, in the data relocation technology, relocation is performed positively in order to increase an average number of data reuses, so in principle the cost is this value.

Further, when the group to which the piece of data belongs is not in the cache, a cost when there is no need for writing back is 20 [ms]. In this case, it is about twice the cost for reading a piece of data 10.01 [ms], so the number of reuses may be not less than two. This is a rare case in which there does not occur relocation or writing.
The cost described above is generated only for the first time, and is 0 [ms] when the group to which the piece of data belongs is in the cache.
The cost for writing a piece of data is obtained by 20 [ms]+20 [ms]=40 ms, as in the case of reading. Also in this case, it is difficult to recover costs unless the number of reuses is not less than four.

The cost when there is no need for reading is 20 ms, and the number of reuses may be not less than two. However, in principle this condition does not occur because reading is needed for relocation and there is a need to read a group once when the group includes at least one piece of data which has not been updated.

As can be seen, in this example, it is generally not possible to absorb the cost for data relocation so as to provide a performance higher than that of the LRU unless a high number of reuses=four is achieved. However, it is sufficient if the number of reuses=two is achieved under a specific condition.

When a group size=100 KB, the cost for reading and writing the group is 11 [ms], where it is sufficient if the number of reuses=2.2 is achieved in general or it is sufficient if the number of reuses=1.1 is achieved under a specific condition. However, it is also difficult to achieve the conditions in this case because the number of pieces of data that belong to the group is reduced to 1/10.

As described above, reading and writing in a scheme of the data relocation technology involves high costs. Next, the cost for reading and writing in a scheme of the data relocation technology is discussed for each of the characteristics of an application.

(1) Application in which there are Almost No Occurrences of Either Reading or Writing

In this case, there does not occur a problem of a throughput performance to be improved by the data allocation technology.

(2) Application in which Reading Rarely Occurs but Writing Often Occurs

The cost for reading is reduced by reading a relocated group all together when reading, but there is only a slight improvement in performance because a proportion of reading among all of the accesses is small.

On the other hand, writing back of a relocated and updated group can be concealed with writing performed by the application, so the apparent cost for relocation is low.

Thus, the rate of an improvement in performance remains low.

(3) Application in which Both Reading and Writing Often Occur

The cost for reading is reduced by reading a relocated group all together when reading, which results in an improvement in performance.

On the other hand, writing back of a relocated and updated group can be concealed with writing performed by the application, so the apparent cost for relocation is low.

Thus, it is possible to improve performance greatly in this case.

(4) Application in which Reading Often Occurs, but Writing Rarely Occurs

The cost for reading is reduced by reading a relocated group all together similarly to when reading, which results in an improvement in performance.

On the other hand, it is not possible to conceal writing back of a relocated and updated group with writing performed by the application, so there often occurs writing back independently by the data relocation technology. Thus, the apparent cost for relocation is high.

As a result, an improvement in performance may remain at a low level or there may be a decrease in performance.

As described above, there may be a decrease in performance in the case of (4) described above, in comparison with the cases of (1) to (3) described above.

Next, how to apply the data relocation technology and buffering is discussed.
A writing all together by use of buffering is a representative method for reducing a cost for writing, and it seems like this permits a reduction in a cost by decreasing the number of write-backs although it is not possible to reduce the number of groups written back.
However, the data relocation technology, which groups pieces of data to write them all together, was originally intended for an improvement in performance using a writing all together. A further writing of the group of data all together will not be successful for the following reason.

A plurality of groups for a writing all together are further written all together, so the size of a single write becomes huge, which results in a great influence of a sequential access performance and in an increase in a cost.

In the situation which is originally assumed for applying the relocation technology described above, the entirety of the size of updated data, that is, the data size which was originally needed to be written all together, is small. Thus, when only a piece of data that has been updated just by use of the LRU is written back, the writing size can be small. Namely, the cost for this situation is lower than that for the situation in which there occurs reading and writing evenly. Thus, the data relocation technology and buffering are relatively disadvantageous over the LRU.

In order to reduce a write cost efficiently using buffering, there is a need to wait until updated groups are collected so as to write them all together. However, a memory will be heavily loaded by processing of waiting until updated groups are collected being performed while further holding a plurality of groups for a writing all together. Namely, it is not possible to devote a large part of the memory to performing this buffering processing, so it is not possible to wait for a long time, which results in being unable to write all together efficiently.

As described above, the data relocation technology is a technology that groups pieces of data, particularly so as to reduce a read cost. The processing including relocating data and changing to a more efficient grouping is performed as appropriate. A read cost in a subsequent access is reduced due to relocation. It is also possible to reduce a write cost, but a simple technology such as buffering provides a similar effect.

However, data relocation involves quite a few costs. Specifically, a main cost is processing of writing back a relocated and updated group. Thus, an architecture for the data relocation technology is such that a set of reading performed by an application and writing of data updated by the application, and writing of a group updated due to relocation, are performed in combination, so as to conceal the cost for the latter.

Thus, a relationship between an advantage of data relocation and a cost due to data relocation depends on a state of data access (that is, the characteristics of an application that performs data access). For example, in an application that does not perform writing or only performs a small amount of writing, it is difficult to perform writing due to relocation in combination, which results in being unable to sufficiently conceal a cost due to relocation, that is, which results in an increase in an apparent cost. As a result, the data relocation technology has a disadvantage over other technologies such as the LRU. On the other hand, if relocation is not performed, a cost is not generated but it is difficult to obtain an advantage of relocation, so it is also not appropriate to suppress relocation.

Embodiments will now be described in detail.

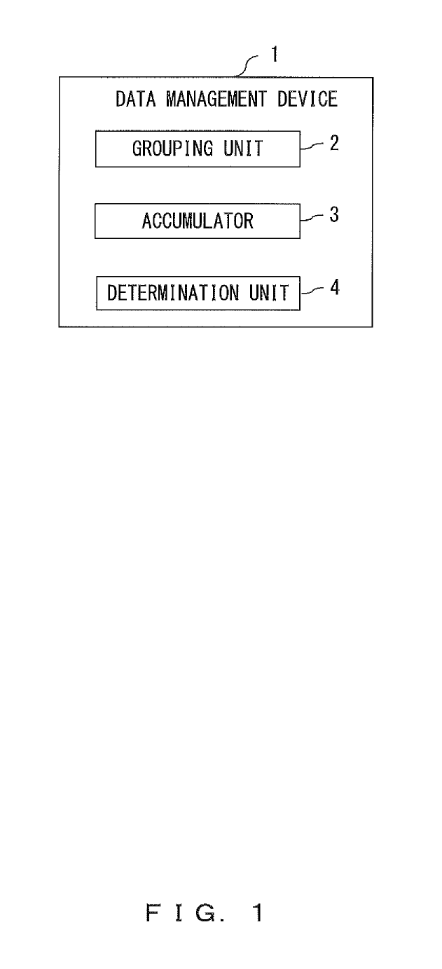

FIG. 1 illustrates an example of a data management device according to the embodiments. A data management device includes a grouping unit 2, an accumulator 3, and a determination unit 4.

The grouping unit 2 generates grouping information that groups data on the basis of a history of a request for an access to the data. An analysis determination unit 22, a relationship analysis unit 23, an allocation determination unit 24, and a relocation unit 25 described later are examples of the grouping unit 2. A data allocation table 31 described later is an example of the grouping information.

The accumulator 3 accumulates, in a buffer and according to a changing request or changing processing, a changed piece of data from among pieces of data included in a group that exists in a memory, the changed piece of data indicating a piece of data changed by the changing request or the changing processing, the changing request requesting a change in data, and the changing processing being processing of changing a group to which the data belongs. The change in data includes an addition, an update, and a deletion. A write-back controller 26 described later is an example of the accumulator 3.

The determination unit 4 determines, for each group included in the grouping information, whether changed data accumulated in the buffer is to be written to a storage device, on the basis of a set condition for writing. The write-back controller 26 described later is an example of the determination unit 4.

Such a configuration permits a reduction in a frequency of writing back to a storage due to data relocation.

When it has determined that the accumulated changed data is to be written to the storage device, the determination unit 4 reflects, in the grouping information, information on a group to which the accumulated changed data belongs. When it has determined that the accumulated changed data is to be written to the storage device, the determination unit 4 reflects the accumulated changed data in a group that corresponds to the changed data in the memory, so as to write it to the storage device.

Such a configuration permits a reflection of updated information in a group in a cache as well as in grouping information, the updated information being accumulated in a buffer as a buffer group.

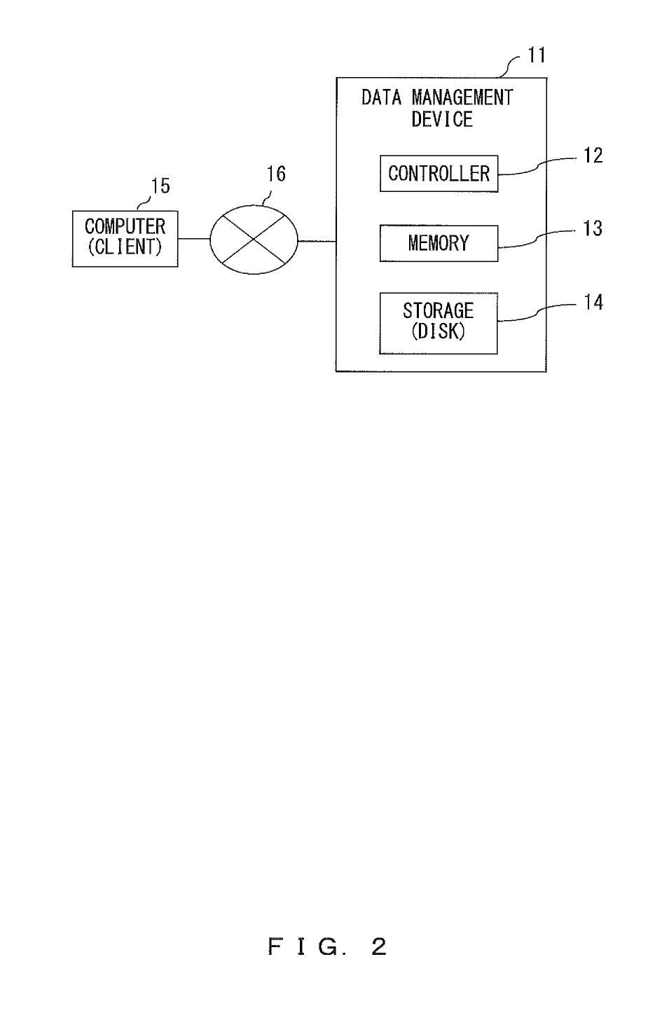

FIG. 2 illustrates an example of a hardware configuration of the data management device according to the embodiments. A data management device 11 includes, for example, a controller 12, a memory device (hereinafter referred to as a “memory”) 13, and a storage 14. Further, the data management device 11 is connected to a client computer (hereinafter referred to as a “client”) 15 that is an example of an information processing device through a communication network (hereinafter referred to as a “network”) 16.

The controller 12 is, for example, a processor such as a central processing unit (CPU) that is an arithmetic processing unit including, for example, a program counter, an order decoder, various calculators, a load store unit (LSU), and a general register.

The memory 13 is storage that can be accessed at a speed higher than that of the storage 14. A random access memory (RAM) and a flash memory are examples of the memory 13. The storage 14 is, for example, a disk with an access speed that is lower than that of the memory 13 such as a hard disk drive (HDD).

The storage 14 has stored, for each group, data provided by the data management device 11. As an example of the embodiments, a group is a set of pieces of data that have been determined to have a relationship, on the basis of a history of a request for an access to data (hereinafter referred to as an access request), and the content is updated by processing performed by the controller 12, as described later. The access request includes a read access request and a write access request. As an example of the embodiments, pieces of data are grouped on the basis of an access history as described above, but the embodiments are not limited to this, but the pieces of data may be grouped on the basis of other information.

For example, a frequently accessed group from among groups stored in the storage 14 is read from the storage 14 to be stored in the memory 13. This permits the data management device 11 to output data at a high speed in response to an input access request.

In addition to having the configuration described above, the data management device 11 includes, for example, a Read Only Memory (ROM) having stored a basic input/output system (BIOS) and a program memory. A program executed by the controller 12 may be obtained through the network 16, or may be obtained by the data management device 11 being provided with a computer-readable portable recording medium such as a portable memory device or a CD-ROM.

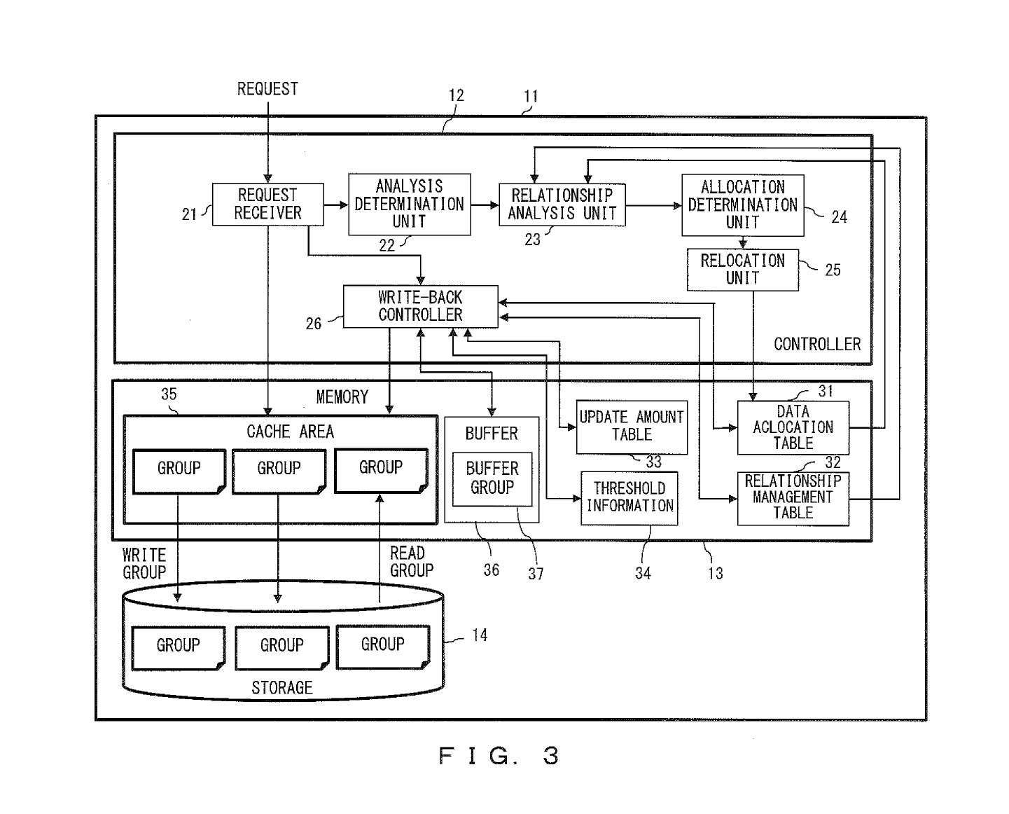

FIG. 3 illustrates an example of a functional configuration of the data management device according to the embodiments. As described above, the data management device 11 includes the controller 12, the memory 13, and the storage 14.

The memory 13 includes a cache area 35 and a buffer 36. The cache area 35 is an area that caches a plurality of groups read from the storage 14 and stores them temporarily.

From among pieces of data held by the cache area 35, the buffer 36 stores a piece of data that has been added, updated, or deleted (that is, a updated portion of the group or a changed portion of the group) as a buffer group 37.

The memory 13 holds the data allocation table 31, a relationship management table 32, an update amount table 33, and threshold information 34.

The data allocation table 31 stores a key that identifies a piece of data, and information that indicates a correspondence relationship between the key and a group to which the piece of data belongs. The relationship management table 32 is a table that sequentially associates each piece of data designated by a request with pieces of data designated by a previous request and manages the accumulated associated information. The update amount table 33 records a total amount of updated data of a group held in the cache area 35.

The threshold information 34 includes a threshold used in the embodiments. The threshold information 34 includes a threshold T1 that is preset with respect to a vacant capacity of a buffer group and a threshold T2 that is preset with respect to a total amount of updated data for each group.

The controller 12 executes a program according to the embodiments so as to serve as a request receiver 21, the analysis determination unit 22, the relationship analysis unit 23, the allocation determination unit 24, the relocation unit 25, and the write-back controller 26.

The request receiver 21 searches the memory 13 in response to a request input from a request source such as the client 15, further searches the storage 14 when a record designated by the request does not exist in the memory 13, and transmits the record designated by the request to the request source. The request is not limited to being transmitted by the client 15. A certain processing entity such as a process executed on the data management device 11 may be an issue source of the request. Further, it is also assumed that a user inputs the request to an input/output device when the input/output device is connected to the data management device 11.

When the request is input, first, the request receiver 21 searches for a piece of data designated by the request in the memory 13. When the piece of data designated by the request exists in the memory 13, the request receiver 21 reads the piece of data from the memory 13 and responds to the request source with the piece of data.

When the piece of data designated by the request does not exist in the memory 13, the request receiver 21 searches for the piece of data designated by the request in the storage 14. When the piece of data designated by the request exists in the storage 14, the analysis determination unit 22 reads all pieces of data included in a group to which the piece of data designated by the request belongs, using the data allocation table 31. Then, the request receiver 21 replies to the request source with the piece of data designated by the request from among all of the pieces of data included in the read group. Here, the request receiver 21 stores, in the memory 13, all of the pieces of data included in the read group.

The case in which, upon receiving a request, the request receiver 21 stores, in the memory 13, all of the pieces of data included in the group read from the storage 14 has been described above, but the embodiments are not limited to this. For example, the request receiver 21 may obtain an access frequency for a predetermined period of time and read a group with a higher access frequency preferentially from the storage 14, so as to store it in the memory 13.

The analysis determination unit 22 determines, using the relationship management table 32, whether groups to which pieces of data designated by consecutive requests belong are the same, and determine whether to cause the relationship analysis unit 23 to analyze a relationship.

According to a result of the determination performed by the analysis determination unit 22, the allocation determination unit 24 analyzes a relationship between each piece of data included in a group to which a piece of data designated by a current request and each piece of data included in a group to which a piece of data designated by a previous request, using the relationship management table 32.

The allocation determination unit 24 determines a group to which data belongs on the basis of a result of the analysis. The relocation unit 25 updates a group location in the data allocation table 31 according to the determination performed by the allocation determination unit 24.

The write-back controller 26 performs the following determination on the basis of a total size of an updated portion of the updated group and a remaining capacity in the buffer group 37, the updated portion being accumulated in the buffer group 37. Namely, the write-back controller 26 determines whether to bring together the updated portion in the past including a current update so as to write back the group to the storage 14, or to keep the current update recorded in the buffer group 37 so as to stop writing back. In the embodiments, it is assumed that, when a group has been updated, the write-back controller 26 records the group temporarily in the buffer group 37 without updating the group directly.

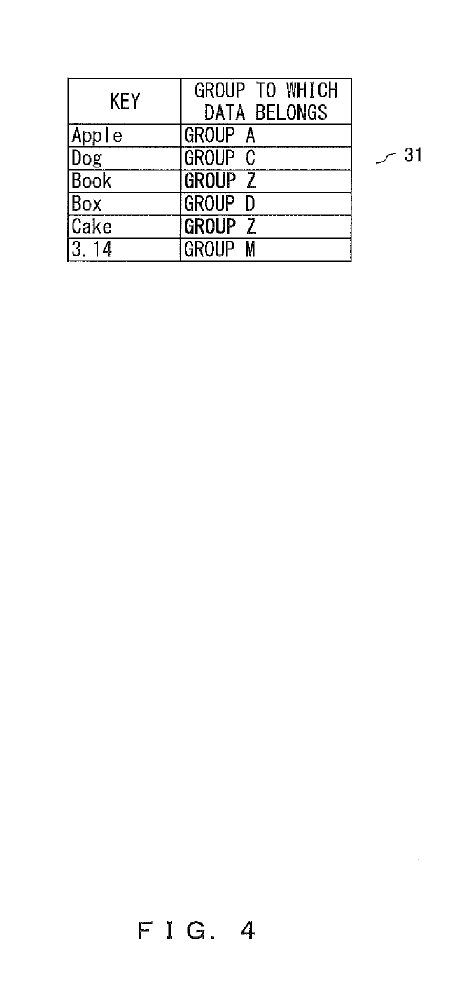

FIG. 4 illustrates an example of a data allocation table according to the embodiments. The data allocation table 31 includes the items “KEY” and “GROUP TO WHICH DATA BELONGS”. “KEY” is a unique piece of information that identifies a piece of data. “GROUP TO WHICH DATA BELONGS” indicates a group to which a piece of data identified by a key belongs.

A buffer group has a specific name, which makes it possible to easily determine whether a group is a buffer group. For example, the buffer group is represented by “GROUP Z” in FIG. 4.

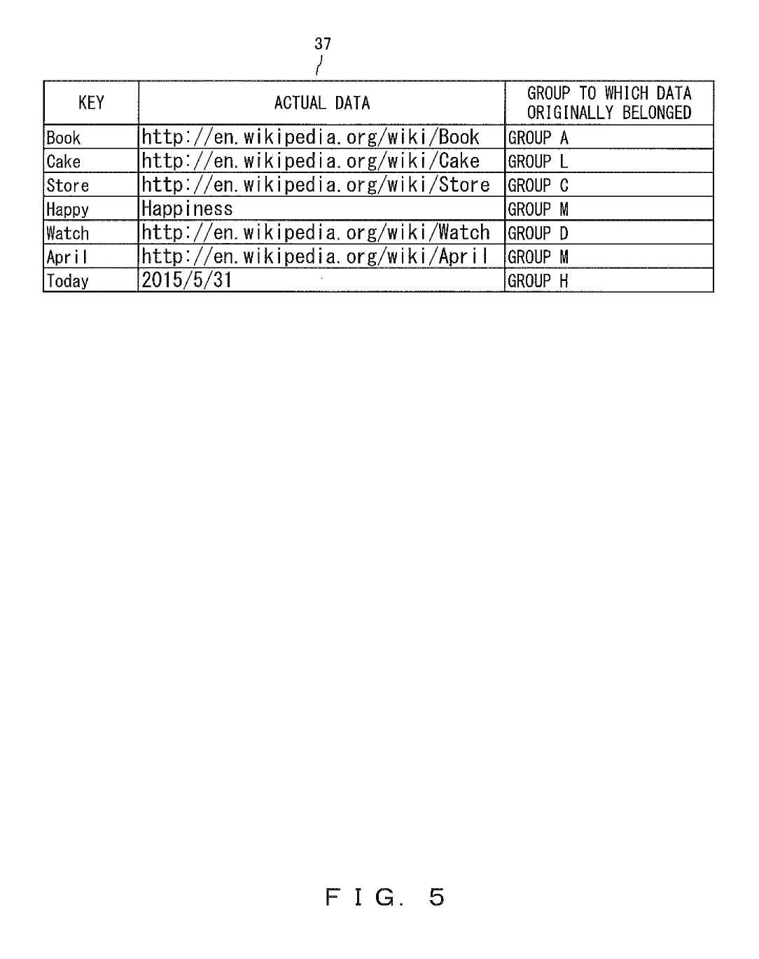

FIG. 5 illustrates an example of a buffer group according to the embodiments. As described above, from among groups held in the cache area 35, the buffer group 37 stores an updated portion of data or an added piece of data that is included in a group to be written back (the buffer group 37).

In the buffer 36, an entry of the buffer group 37 includes the items “KEY”, “ACTUAL DATA”, and “GROUP TO WHICH DATA ORIGINALLY BELONGED”. “KEY” stores a unique piece of information that identifies a piece of data. “ACTUAL DATA” stores an updated piece of data or a newly added piece of data. “GROUP TO WHICH DATA ORIGINALLY BELONGED” stores a group to which a piece of data belongs before an update or an addition. When a piece of data has been newly added, “GROUP TO WHICH DATA ORIGINALLY BELONGED” is empty because there exists no group to which the piece of data originally belonged.

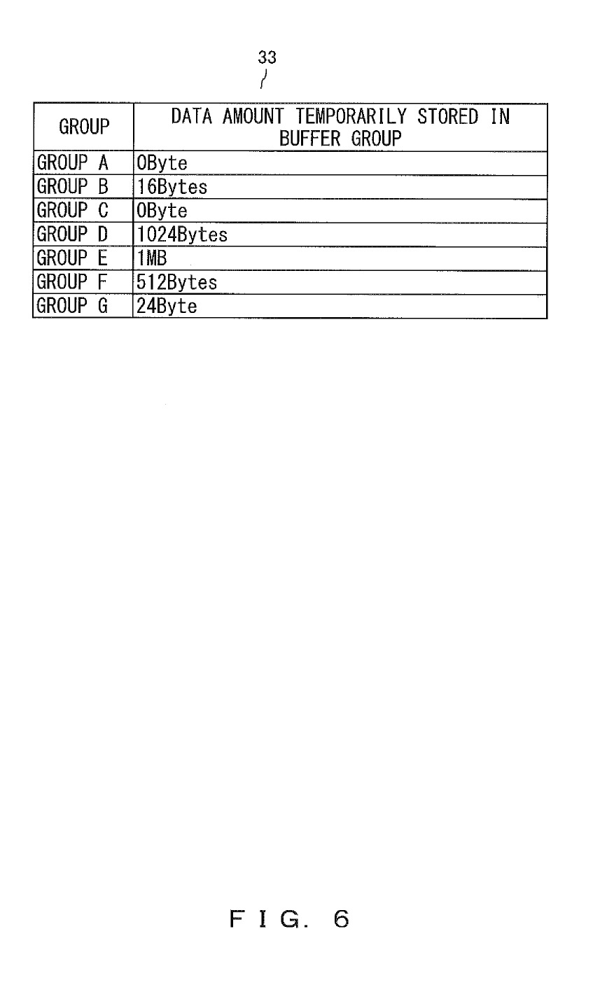

FIG. 6 illustrates an example of an update amount table according to the embodiments. The update amount table 33 stores a total amount of updated data of a group that is held in the cache area 35, but it may store a total amount of updated data of a group that is not held in the cache area 35.

The update amount table 33 includes the items “GROUP” and “DATA AMOUNT TEMPORARILY STORED IN BUFFER GROUP”. “GROUP” stores a name of a group that is held in the cache area 35, but it may store a name of a group that is not held in the cache area 35.

“DATA AMOUNT TEMPORARILY STORED IN BUFFER GROUP” stores a data amount of a group temporarily stored in the buffer group 37.

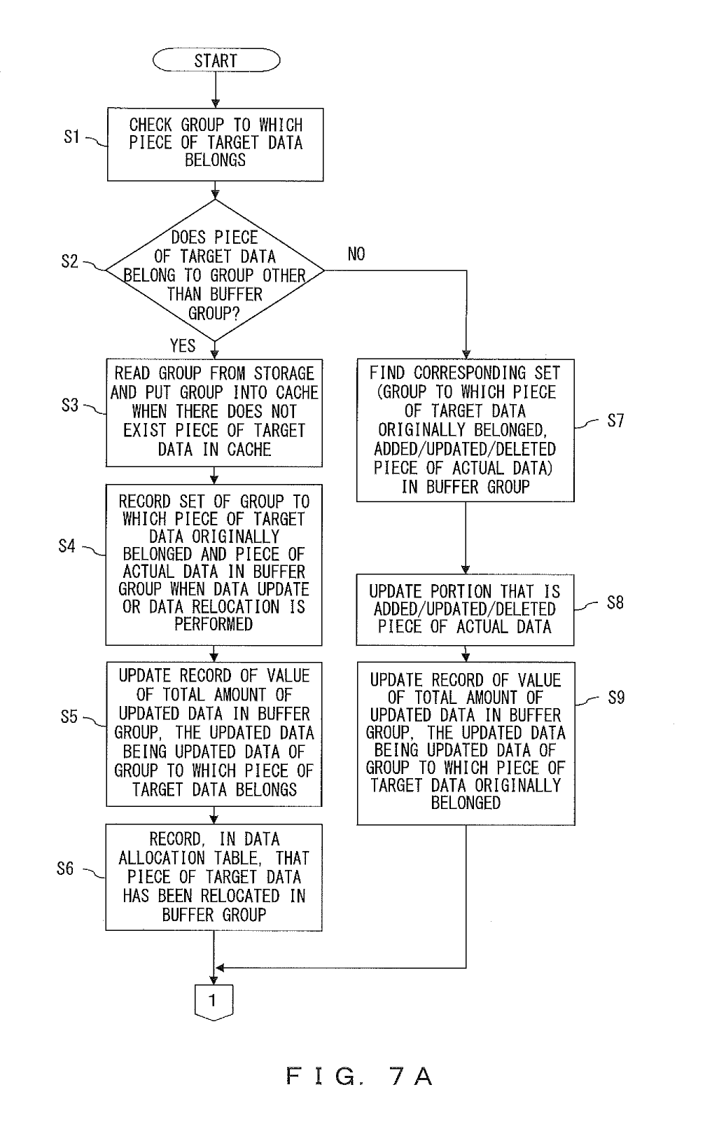

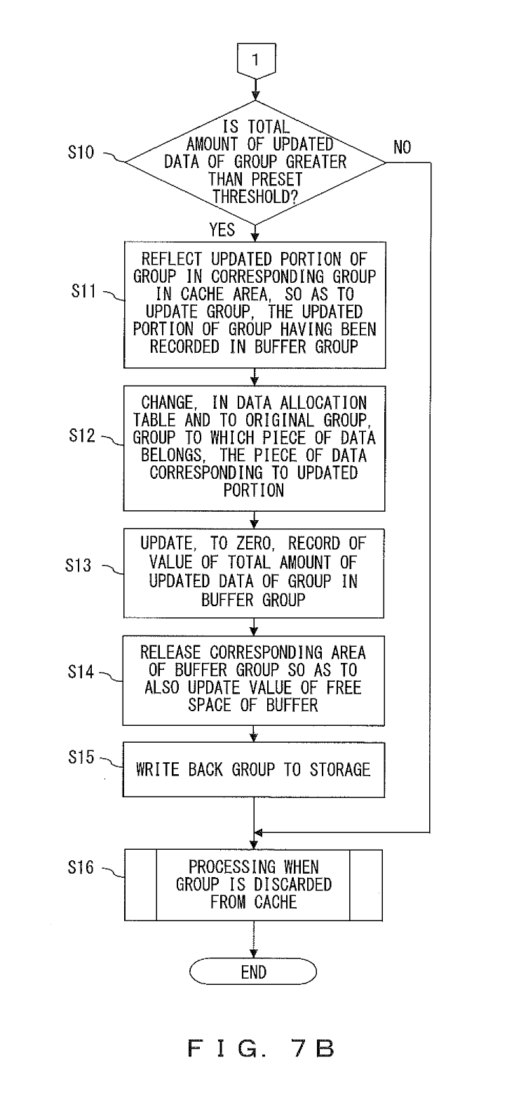

FIGS. 7A and 7B illustrate a flow when a group is updated by performing a data updating (including a deletion) or a data relocation according to the embodiments.

Upon receiving a request for an update or a deletion of a piece of target data, the request receiver 21 checks a group to which a piece of target data belongs on the basis of the data allocation table 31 (S1).

As a check result, when the piece of target data belongs to a group other than the buffer group 37 (“YES” in S2), the request receiver 21 performs the following processing. Here, when there does not exist the piece of target data in the cache area 35, the request receiver 21 reads the group to which the piece of target data belongs from the storage 14, and stores the group in the cache area 35 (S3).

When it performs a data update or a data relocation, the write-back controller 26 does not update the group directly, but records, in the buffer group 37, a set of the group to which the added, updated, or deleted piece of target data originally belonged and a piece of actual data of the piece of target data (S4).

When the piece of target data has been deleted, the write-back controller 26 does not record the piece of actual data, but record a flag indicating a completion of deletion. Further, a data relocation (a data movement between groups) is treated as a deletion of data from one group and an addition of new data to another group.

In the update amount table 33, the write-back controller 26 updates a record of a value of a total amount of updated data in the buffer group 37, the updated data being updated data of the group to which the piece of target data belongs (S5).

In the data allocation table 31, the write-back controller 26 updates the group name of the piece of target data to a group name indicating the buffer group 37. Namely, the write-back controller 26 records, in the data allocation table 31, that the piece of target data has been relocated in the buffer group 37 (S6).

As the check result in S2, when the piece of target data belongs to the buffer group 37 (“NO” in S2), the request receiver 21 performs the following processing. The request receiver 21 searches in the buffer group 37 for an entry corresponding to the piece of target data (a set of the group to which the piece of target data originally belonged and an added/updated/deleted piece of target actual data) (S7).

The write-back controller 26 updates a portion that is the piece of actual data of the piece of target data with respect to an entry obtained by the search (S8).

In the update amount table 33, the write-back controller 26 updates a record of a value of a total amount of updated data in the buffer group, the updated data being updated data of the group to which the piece of target data originally belonged (S9).

After the process of S6 or S9 is terminated, the write-back controller 26 determines whether the total amount of updated data of the group is greater than the threshold T2, the total amount of updated data having been updated in the update amount table 33 in S6 or S9 (S10). When the updated total amount of updated data is not greater than the threshold T2 (“NO” in S10), the flow is terminated.

When the updated total amount of updated data is greater than the threshold T2 (“YES” in S10), the write-back controller 26 reflects the updated portion of the group in a corresponding group in the cache area, so as to update the group, the updated portion of the group having been recorded in the buffer group 37 (S11).

In the data allocation table 31, the write-back controller 26 changes, to an original group name, the name of a group to which a piece of data belongs on the basis of “GROUP TO WHICH DATA ORIGINALLY BELONGED” of the buffer group 37, the piece of data corresponding to the updated portion of the group (S12).

In the update amount table 33, the write-back controller 26 updates, to zero, a record of a value of a total amount of updated data of the group in the buffer group 37 (S13).

The write-back controller 26 releases a buffer that holds the buffer group 37 (a set of a group to which a piece of data originally belonged and an added/updated/deleted piece of actual data) so as to also update a value of a free space of the buffer group (S14).

The write-back controller 26 writes back the group updated in S11 to the storage 14 (S15).

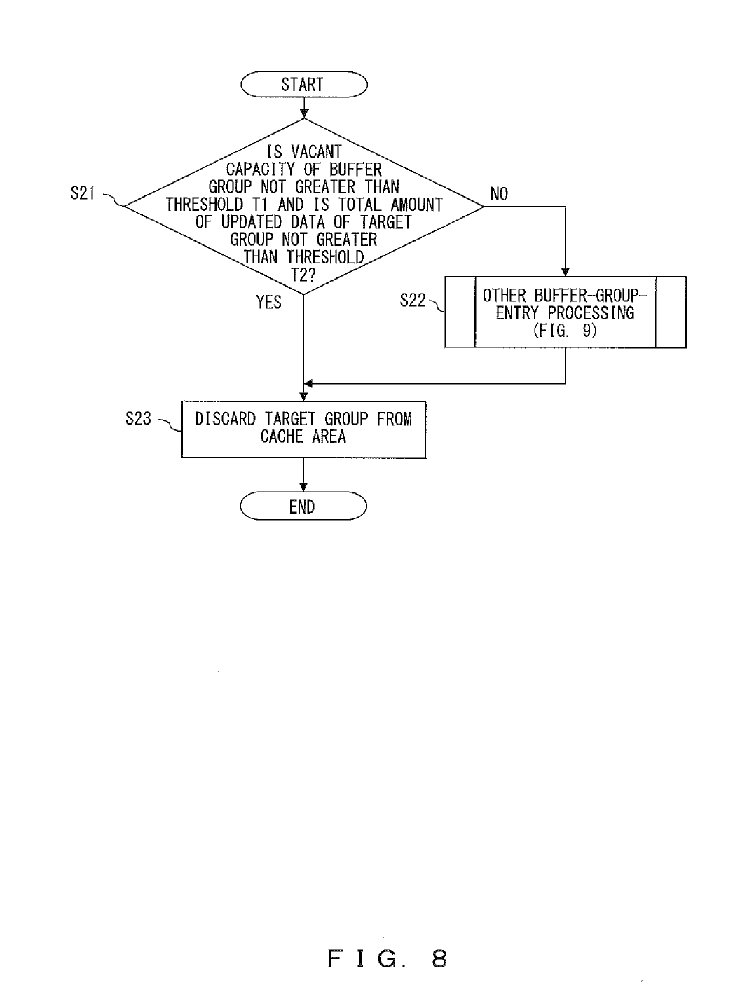

When it discards the group from the cache area 35, the write-back controller 26 performs processing of FIG. 8 (S16).

FIG. 8 illustrates a flow when a target group is discarded from a cache (S16) according to the embodiments. The write-back controller 26 determines whether a vacant capacity of the buffer group 37 is not greater than the threshold T1 and a total amount of updated data of a discard target group is not greater than the threshold T2 (S21). When the vacant capacity of the buffer group 37 is not greater than the threshold T1 and the total amount of updated data of the discard target group is not greater than the threshold T2 (“YES” in S21), the write-back controller 26 discards the content of the target group from the cache area 35 (S23).

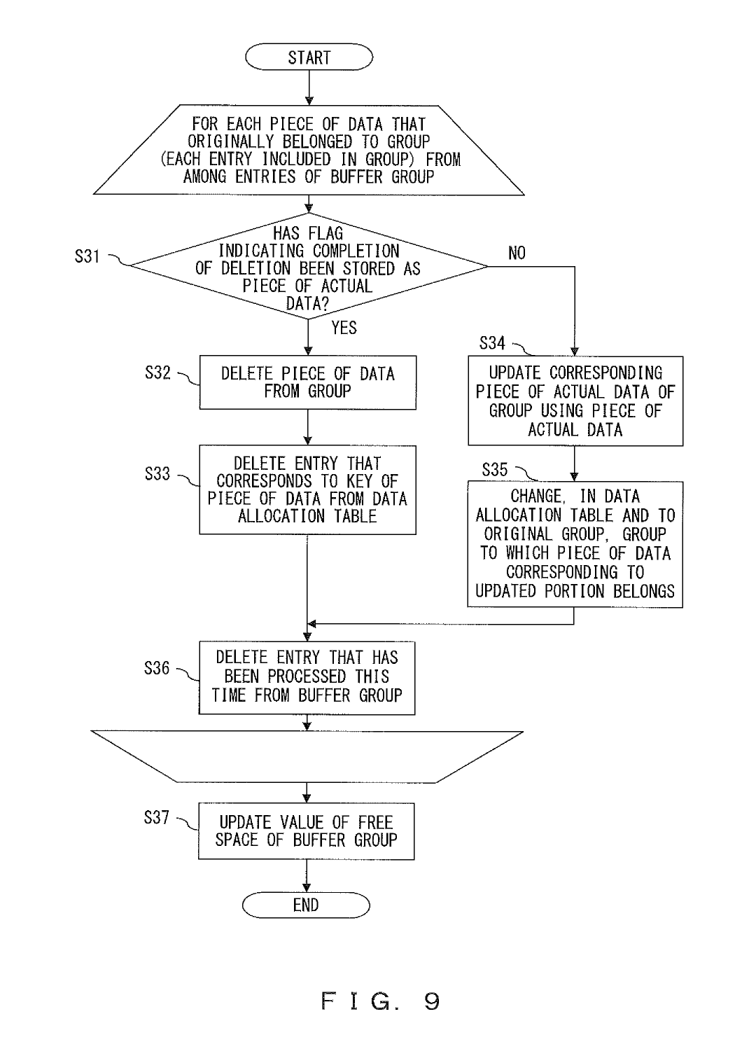

When the vacant capacity of the buffer group 37 is greater than the threshold T1 or when the total amount of updated data of the discard target group is greater than the threshold T2 (“NO” in S21), the write-back controller 26 performs other buffer-group-entry processing (S22). The process of S22 is described in detail in FIG. 9.

After the process of S22, the write-back controller 26 discards the content of the target group from the cache area 35 (S23).

FIG. 9 illustrates a flow of the other buffer-group-entry processing (S22, S54). The write-back controller 26 performs the following processes of S31 to S36 for each entry of a piece of data included in the group to which the piece of target data originally belonged from among entries of the buffer group 37.

The write-back controller 26 refers to an entry of the buffer group 37 and determines whether the item “ACTUAL DATA” of the buffer group 37 of the entry has stored therein a flag indicating that data has already been deleted (S31).

When the flag indicating that data has already been deleted has been stored in the item “ACTUAL DATA” of the buffer group 37 of the entry (“YES” in S31), the write-back controller 26 performs the following processing. The write-back controller 26 deletes a piece of data corresponding to a key to which the flag is attached from the group in the cache area 35 which is described in the item “GROUP TO WHICH DATA ORIGINALLY BELONGED” (S33).

The write-back controller 26 deletes an entry that corresponds to the key of the deleted piece of data from the data allocation table 31 (S33).

In S31, when the flag indicating that data has already been deleted is not stored in the item “ACTUAL DATA” of the buffer group 37 of the entry (“NO” in S31), the write-back controller 26 performs the following processing. The write-back controller 26 updates a piece of actual data that corresponds to the group in the cache area 35 using actual data stored in the item “ACTUAL DATA” (S34).

In the data allocation table 31, the write-back controller 26 changes, to the original group, the group to which a piece of data corresponding to the updated portion of the group belongs, on the basis of “GROUP TO WHICH DATA ORIGINALLY BELONGED” of the buffer group 37 (S35).

After the process of S33 or S35 is terminated, the write-back controller 26 deletes the entry that has been processed this time from the buffer group 37 (S36).

After the processes of S3 to S36 are terminated, the write-back controller 26 updates a value of a free space of the buffer group (S37).

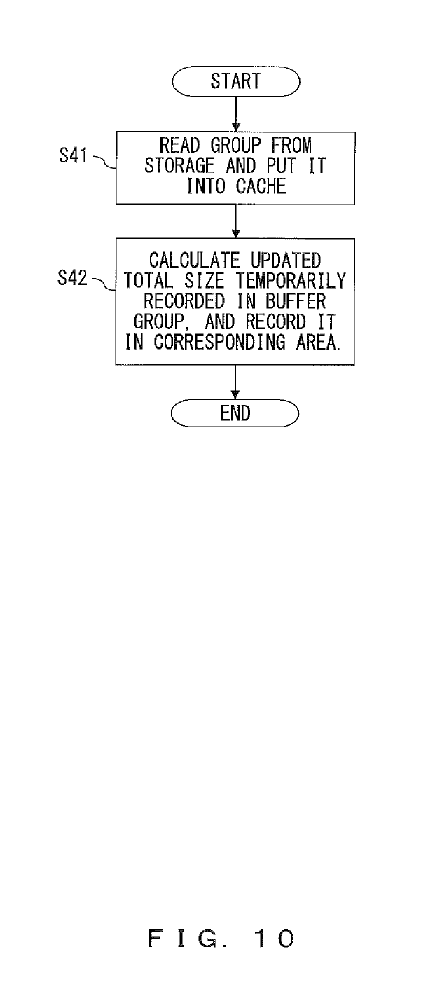

FIG. 10 illustrates a flow of processing of reading a group according to the embodiments. The request receiver 21 reads a group from the storage 14 and stores the group in a cache (S41).

The write-back controller 26 calculates an updated total size of actual data for each group, and records it in “DATA AMOUNT TEMPORARILY STORED IN BUFFER GROUP” of the update amount table 33, the updated total size of actual data having been temporarily recorded in the buffer group 37 (S42). Here, it is assumed that a group in the storage 14 does not hold an updated total size, but the group may hold it so that the group all together is written to or read from the storage 14.

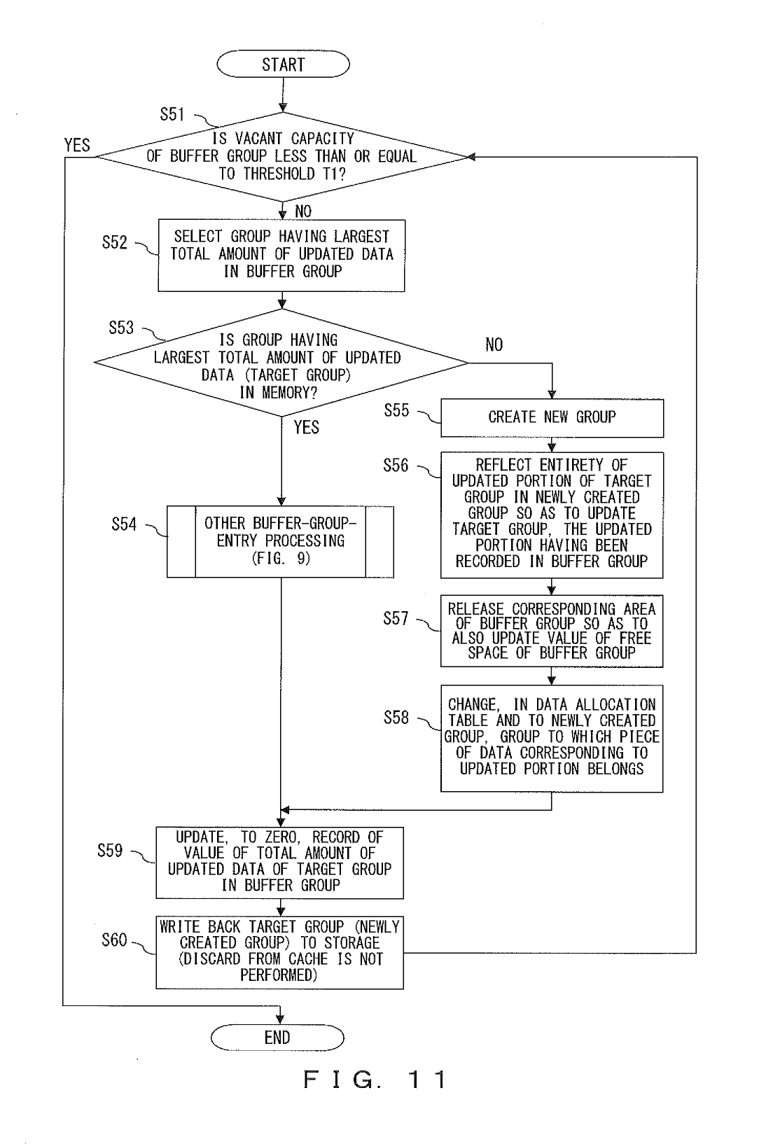

FIG. 11 illustrates a processing flow when a remaining capacity of a buffer group has become low according to the embodiments. The write-back controller 26 performs the following processing when it has been detected that a remaining capacity of the buffer group 37 has become low, or performs it regularly.

When the vacant capacity of the buffer group 37 is less than or equal to the threshold T1 (“YES” in S51), the processing is terminated.

When the vacant capacity of the buffer group 37 is greater than the threshold T1 (“NO” in S51), the write-back controller 26 refers to the update amount table 33 and selects a group having a largest total amount of updated data (a target group) in the buffer group 37 (S52).

When the group having a largest total amount of updated data is in the memory 13 (“YES” in S53), the write-back controller 26 performs the processing of FIG. 9 (S54).

When the group having a largest total amount of updated data is not in the memory 13 (“NO” in S53), the write-back controller 26 creates a new group in the cache area 35.

The write-back controller 26 reflects the entirety of the updated portion of the target group in the group newly created in the cache area 35 so as to update the target group, the updated portion having been recorded in the buffer group 37 (S56).

The write-back controller 26 releases a corresponding area of the buffer group (a set of a group to which a piece of data originally belonged and an added/updated/deleted piece of actual data) so as to also update a value of a free space of the buffer group 37(S57).

In the data allocation table 31, the write-back controller 26 changes, to a name of the newly created group, the name of a group to which a piece of data belongs, the piece of data corresponding to the updated portion of the target group (S58).

The write-back controller 26 updates, to zero, a record of a value of a total amount of updated data of the newly created group in the buffer group 37 (S59).

The write-back controller 26 writes back the newly created group to the storage 14. Here, the newly created group which is held in the cache area will not be discarded (S60). After that, the process returns to S51.

When data is moved between groups due to relocation, such a movement is treated as a deletion of data from a group before movement and an addition of data to a group after movement. It is doubly recorded in the buffer group 37 as entries of a creation and a deletion, and only the group after movement is recorded in the data allocation table 31.

An example of the embodiments is described below.

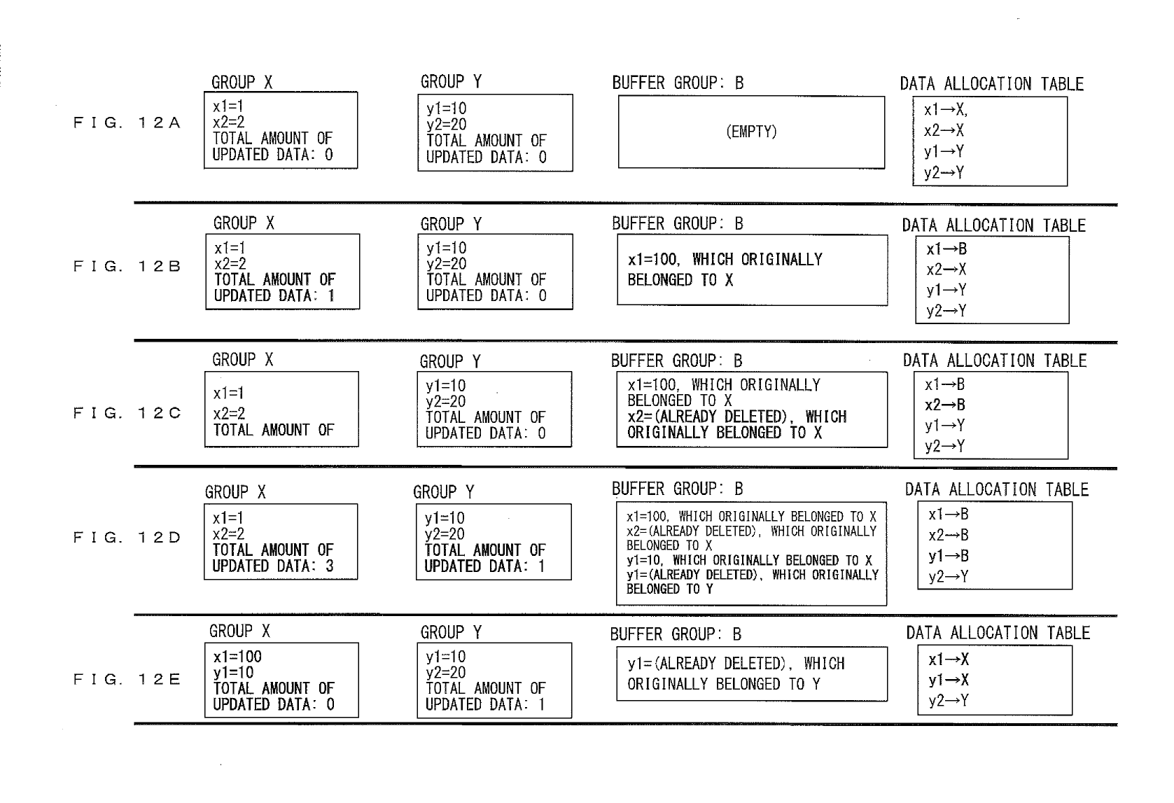

FIG. 12 is a diagram that explains an example of the embodiments. As indicated by FIG. 12A, a group X has stored therein pieces of data x1=1, x2=2, . . . . A group Y has stored therein pieces of data y1=10, y2=20, . . . . It is assumed that a buffer group B is empty at first. It is assumed that, at this point, the groups X and Y are not updated (both a total amount of updated data of the group X and a total amount of updated data of the group Y are zero), and the content recorded in the storage 14 and information deployed in the cache area 35 are identical, so there is no need for writing back. In the example, in order to facilitate understanding, it is assumed that both of the two thresholds are infinite. It is also assumed that all of the data sizes are one.

FIG. 12B indicates a state when x1 has been changed to x1=100. The content of the change is recorded in the buffer group B because the buffer group B is empty. Further, the total amount of updated data of the group X=1. The group to which x1 belongs is changed to the buffer group B in a data allocation table.

FIG. 12C indicates a state when x2 has been deleted. This is also recorded in the buffer group B. The total amount of updated data of the group X=2 because a deletion also increases a total amount of updated data. Further, the group to which x2 belongs is changed to the buffer group B in the data allocation table.

FIG. 12D indicates a state when y1 has been moved from the group Y to the group X. When pieces of data of the groups X and Y are changed, the groups X and Y are not updated directly, but the content of the change is recorded in the buffer group B. This results in obtaining the total amount of updated data of the group X=3 and the total amount of updated data of the group Y=1. Further, the group to which y1 belongs is changed to the buffer group B in the data allocation table.

FIG. 12E indicates a state when the group X has been discarded from a cache. The group X has been updated, so it is not possible to perform a discard from the cache. In this case, updated information in the buffer group B is reflected in the group X situated in the cache area 35, x1 and y1 are respectively updated to x1=100 and y1=10, and the updated information is written back to the storage 14. This results in obtaining the total amount of updated data of the group X=0. Further, the updated information on the group X is deleted from the buffer group B. Furthermore, the group to which x1 and y1 belong is changed to a buffer group X in the data allocation table.

As described above, in the embodiments, an updated group is not written back to a storage every time it is discarded from a cache. In the embodiments, when a total amount of updated data is small, the write-back controller 26 records, in another area (a buffer group) in the cache, an updated portion and a name of a group to which the updated piece of data originally belonged. Along with this, the write-back controller 26 records, in the data allocation table 31, in which buffer group the data and the group have been recorded, instead of recording a correspondence between them. Here, the updated content is held by the buffer group, so there is no need to write back the updated content to the storage 14, and the group is just discarded from the cache.

When a read from a storage and a discard from a cache are repeated with respect to the same group, an updated portion of the group is accumulated in a buffer group. Thus, when the updated portion is accumulated to some extent, the group including the updated portion is written back to the storage 14. Then, a record of the updated portion and the group to which the updated portion (updated data) originally belonged is discarded, the record being situated in the buffer group.

Accordingly, just one writing back is performed for several discards to a few dozen discards even though there was previously a need for writing back every time a group was discarded from a cache. This results in being able to reduce a write cost, that is, to reduce a cost even when the data relocation technology is used.

According to the embodiments, the write-back controller 26 that controls a writing back of a group performs the following processing when a certain updated group is discarded from a cache. The write-back controller 26 performs the following determination on the basis of a total size of an updated portion of the updated group and a remaining capacity in the buffer group 37, the updated portion being accumulated in the buffer group. The write-back controller 26 determines whether to bring together the updated portion in the past including a current update so as to write back the group, or to keep the current update recorded in the buffer group so as to stop writing back. Here, it is assumed that, when the group is updated, the write-back controller 26 records the group temporarily in the buffer group without updating the group directly.

Accordingly, it is possible to decrease the number of write-backs of a group performed by the data relocation technology, by writing back a group or by keeping a current update recorded in a buffer group.

Before the embodiments are applied, a performance of an application in which there occurs no writing or there occurs almost no writing has been decreased due to writing that occurred previously every time a group was discarded from a cache. According to the embodiments, it becomes possible to decrease the number of writings by bringing together several writings to a few dozen writings into one, which results in improving performance. Thus, it is possible to decrease a frequency of writing back to a storage due to data relocation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recoding medium having stored therein a data management program that causes a computer to execute a process comprising:
generating grouping information that groups data based on a history of a request for an access to the data;
accumulating, in a buffer, according to a changing request or changing processing, a changed piece of data from among pieces of data included in a group that exists in a memory, the changed piece of data indicating a piece of data changed by the changing request or the changing processing, the changing request requesting a change in data that includes an addition, an update, and a deletion, the changing processing being processing of changing a group to which the data belongs; and
determining, for each group included in the grouping information, whether the changed data accumulated in the buffer is to be written to a storage device, based on a set condition for writing.

2. The data management program according to claim 1, wherein
when the accumulated changed data is determined to be written to the storage device, information on a group to which the accumulated changed data belongs is reflected in the grouping information.

3. The data management program according to claim 1, wherein
when the accumulated changed data is determined to be written to the storage device, the accumulated changed data is reflected in the group in the memory and is written to the storage device, the group corresponding to the changed data.

4. The data management program according to claim 1, wherein
the set condition for writing is a condition based on a vacant capacity in the buffer or based on a total data amount of updated data for each group in the buffer.

5. A data management device comprising:
a memory; and
a processor coupled to the memory and the processor configured to execute a process including:
generating grouping information that groups data based on a history of a request for an access to the data;
accumulating, in a buffer, according to a changing request or changing processing, a changed piece of data from among pieces of data included in a group that exists in a memory, the changed piece of data indicating a piece of data changed by the changing request or the changing processing, the changing request requesting a change in data that includes an addition, an update, and a deletion, the changing processing being processing of changing a group to which the data belongs; and
determining, for each group included in the grouping information, whether the changed data accumulated in the buffer is to be written to a storage device, based on a set condition for writing.

6. A data management method conducted by a computer, the data management method comprising:
generating grouping information that groups data based on a history of a request for an access to the data;
accumulating, in a buffer, according to a changing request or changing processing, a changed piece of data from among pieces of data included in a group that exists in a memory, the changed piece of data indicating a piece of data changed by the changing request or the changing processing, the changing request requesting a change in data that includes an addition, an update, and a deletion, the changing processing being processing of changing a group to which the data belongs; and
determining, for each group included in the grouping information, whether the changed data accumulated in the buffer is to be written to a storage device, based on a set condition for writing.
